(19) United States
(12) Patent Application Publication
(10) Pub. No.: US 2024/0208124 A1
(43) Pub. Date: Jun. 27, 2024

(54) MOLDED ARTICLE PRODUCTION SYSTEM

(71) Applicant: SUMITOMO HEAVY INDUSTRIES, LTD., Tokyo (JP)

(72) Inventors: Katsunobu HANO, Chiba-shi (JP); Tomonori HORIKAWA, Chiba-shi (JP); Takuya MATSUNAGA, Chiba-shi (JP)

(21) Appl. No.: 18/346,237

(22) Filed: Jul. 2, 2023

Related U.S. Application Data
(63) Continuation of application No. PCT/JP2022/016335, filed on Mar. 30, 2022.

(30) Foreign Application Priority Data
Mar. 31, 2021 (JP) 2021-062364

(51) Int. Cl. B29C 45/76; B29C 45/17

(52) U.S. Cl. CPC B29C 45/76; B29C 45/1769; B29C 2945/76899; B29C 2945/76939

(57) ABSTRACT

A molded article production system includes: a first writing unit that writes first information about a molded article molded by an injection molding machine in a readable/writable storage medium; and a transport unit that transports the molded article and the storage medium in which the first information of the molded article is written in association with each other.

### CROSS-REFERENCE TO RELATED APPLICATIONS

This is a bypass continuation of International PCT Application No. PCT/JP2022/016335, filed on Mar. 30, 2022, which claims priority to Japanese Patent Application No. 2021-062364, filed on Mar. 31, 2021, which are incorporated by reference herein in their entirety.

### BACKGROUND

### Technical Field

A certain embodiment of the present invention relates to a molded article production system.

### Description of Related Art

In an injection molding machine, production is not completed at a stage where a molded article is molded, and the molded article is shipped as a product after being processed in various post-process. In recent years, various proposals have been made in order to manage a molded article molded by an injection molding machine in post-process.

### SUMMARY

According to an embodiment of the present invention, there is provided a molded article production system including: a first writing unit that writes first information about a molded article molded by an injection molding machine in a readable/writable storage medium; and a transport unit that transports the molded article and the storage medium in which the first information of the molded article is written in association with each other.

### BRIEF DESCRIPTION OF THE DRAWINGS

FIG. 1 is a diagram illustrating a configuration of a molded article production system according to an embodiment.

FIG. 2 is a diagram showing an example of a storage container according to the embodiment.

FIG. 3 is a diagram illustrating an injection molding machine according to the embodiment and peripheral configurations of the injection molding machine.

FIG. 4 is a diagram illustrating information read and written with respect to an RFID tag by an RFID reader/writer in a molding process according to the embodiment.

FIG. 5 is a diagram illustrating information read and written with respect to the RFID tag by the RFID reader/writer in a take-out/carry-out process according to the embodiment.

FIG. 6 is a diagram illustrating information read and written with respect to the RFID tag by the RFID reader/writer in an inspection process according to the embodiment.

FIG. 7 is a diagram illustrating information read and written with respect to the RFID tag by the RFID reader/writer in a packaging process according to the embodiment.

FIG. 8 is a flowchart showing a processing procedure that is performed in the molding process according to the production system according to the embodiment.

FIG. 9 is a flowchart showing a processing procedure that is performed in the take-out/carry-out process according to the production system according to the embodiment.

FIG. 10 is a flowchart showing a processing procedure that is performed in the inspection process according to the production system according to the embodiment.

FIG. 11 is a flowchart showing a processing procedure that is performed in a transport process according to the production system according to the embodiment.

### DETAILED DESCRIPTION

The related art discloses a technique for imparting a two-dimensional code to a container when a plurality of molded resin bottles are accommodated in the container. Information about a lot is stored in the two-dimensional code. Such a two-dimensional code has an issue in that it is difficult to write new information. That is, since various types of processing are performed on a molded article in post-process after molding, it is preferable that the processing results can be written.

It is desirable to provide a technique for appropriately managing each molded article by associating the molded article with a readable/writable storage medium, to improve the accuracy of quality control of the molded article.

According to an aspect of the present invention, appropriate management is performed for each molded article to improve the accuracy of quality control of the molded article.

Hereinafter, an embodiment of the present invention will be described with reference to the drawings. In each drawing, identical or corresponding configurations are denoted by identical or corresponding reference numerals, and description thereof is sometimes omitted.

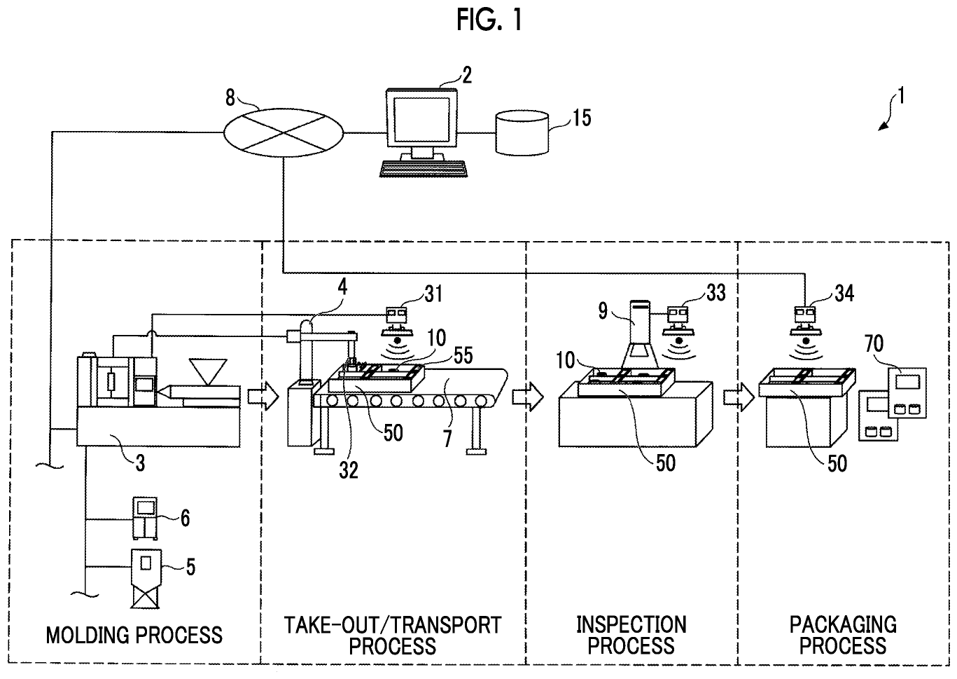

FIG. 1 is a diagram illustrating the configuration of a production system 1 (an example of a molded article production system) according to an embodiment. The production system 1 shown in FIG. 1 includes a management system server 2, an injection molding machine 3, a take-out robot 4, a material dryer 5, a mold temperature controller 6, and an image inspection device 9. Further, the production system 1 according to the present embodiment includes a plurality of RFID reader/writers 31 to 34.

The management system server 2 is a server that manages information of each device of the production system 1. The management system server 2 includes a storage device 15. The management system server 2 manages information received from each device (for example, the RFID reader/writer 34) of the production system 1 in the storage device 15. However, depending on a device that is included in the production system 1, there is a case where the device cannot be connected to a network and cannot transmit information to the management system server 2. In contrast, the production system 1 according to the present embodiment can collect information even from a device that is not connected to the network by using an RFID tag 55. The production system 1 according to the present embodiment can collect information necessary for the process even in the device that is not connected to a network, and store information obtained in the process.

In the production system 1 according to the present embodiment, various types of processing are performed after a molded article 10 is molded by the injection molding machine 3. The production system 1 according to the present embodiment includes, as processing processes, a molding process, a take-out/carry-out process, an inspection process, and a packaging process. The present embodiment shows an example of each processing process, and may include other processes.

In the production system 1 according to the present embodiment, information about the processing performed in the processing process for each processing process is written in a storage medium associated with the processed molded article 10. In the present embodiment, the RFID tag 55 is used as the storage medium. However, any other storage medium may be used as long as it is a readable and writable storage medium.

The RFID (radio-frequency identification) tag 55 is a storage medium in which information can be read and written by the RFID reader/writers 31 to 34 through short-range (in a range of several centimeters to several meters according to a frequency band) wireless communication.

The RFID tag 55 of the present embodiment is provided in association with the molded article 10. In the present embodiment, a storage container 50 is used to associate with the molded article 10.

A belt conveyor 7 (an example of a transport unit) transports the storage container 50 with the molded article 10 stored therein between the processing processes. Although not shown in FIG. 1, the processing processes are connected by the belt conveyor 7. In the present embodiment, an example in which the belt conveyor 7 is used as an example of the transport unit is described. However, the transport unit is not limited to the belt conveyor 7, and any means may be used as long as it can transport the RFID tag and the molded article 10 in association with each other between the processing processes.

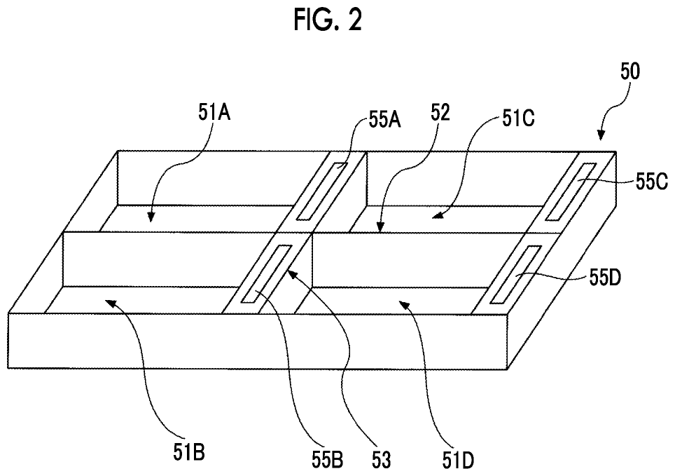

FIG. 2 is a diagram showing an example of the storage container 50 according to the present embodiment. The storage container 50 shown in FIG. 2 has four storage areas 51A to 51D partitioned by partitions 52 and 53. The number of storage areas 51A to 51D in the present embodiment corresponds to the number of cavities of a mold unit of the injection molding machine 3. That is, the production system 1 according to the present embodiment stores all the molded articles 10 taken out from the cavities in the storage areas and transports the molded articles 10 every time the injection molding machine 3 performs molding.

As shown in FIG. 2, the storage container 50 is provided with RFID tags 55A to 55D (in the case of any RFID tag, it is also referred to as the RFID tag 55) associated with the storage areas 51A to 51D. In the present embodiment, one molded article 10 is stored in each of the storage areas 51A to 51D. In this way, each of the RFID tags 55A to 55D can be associated with the molded article 10. In the storage container 50 of the present embodiment, a case where four molded articles 10 are stored is described. However, the number of stored molded articles 10 is not limited to four. The storage container 50 is provided with partitions so as to be able to accommodate the molded articles 10 by the number of molded articles 10 (the number of cavities) that are molded by the injection molding machine 3 at one time.

Returning to FIG. 1, the RFID reader/writers 31 to 34 are provided for each processing process that is performed by the production system 1. The RFID reader/writers 31 to 34 perform reading and writing of information with respect to each of the RFID tags 55A to 55D for each processing process.

Next, the processing processes will be described. The molding process is a process in which the injection molding machine 3 molds the molded article 10. The production system 1 according to the present embodiment includes the injection molding machine 3, the material dryer 5, and the mold temperature controller 6, as the devices that are used in the molding process.

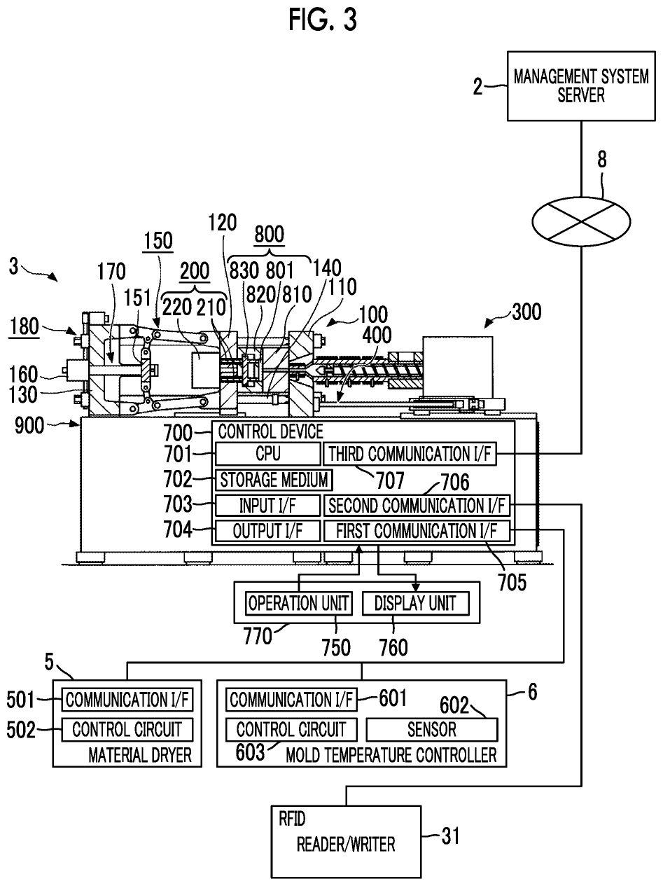

FIG. 3 is a diagram illustrating the injection molding machine 3 according to the present embodiment and the peripheral configurations of the injection molding machine 3. In the example shown in FIG. 3, the material dryer 5 and the mold temperature controller 6 are provided as the peripheral configurations of the injection molding machine 3. Further, in the production system 1, the injection molding machine 3 and the management system server 2 are connected via a public network 8.

The material dryer 5 is a device for drying a molding material (for example, resin) that is put into a feed port of the injection molding machine 3, and includes a communication I/F 501 and a control circuit 502.

The control circuit 502 is a device that controls the entire material dryer 5. The communication I/F 501 is an interface for communicating with a control device 700 of the injection molding machine 3. The control circuit 502 of the present embodiment transmits data regarding the material dryer 5 to the control device 700 via the communication I/F 501. A temperature set for drying and actual data of a drying temperature of the molding material are included in the data regarding the material dryer 5 (hereinafter also referred to as dryer data).

The mold temperature controller 6 is a device for adjusting the temperature of a mold unit 800 of the injection molding machine 3, and includes a communication I/F 601, a sensor 602, and a control circuit 603. In the present embodiment, an example in which the mold temperature controller 6 includes the sensor 602 is described. However, the present embodiment is not limited to an example in which the mold temperature controller 6 is provided with the sensor 602. For example, the sensor 602 may be provided on the mold unit 800.

The sensor 602 acquires the temperature of the mold unit 800 of the injection molding machine 3. The control circuit 603 is a device that controls the entire mold temperature controller 6. The communication I/F 601 is an interface for communicating with the control device 700 of the injection molding machine 3. The control circuit 603 of the present embodiment adjusts the temperature of the mold unit 800, based on the temperature acquired from the sensor 602. Further, the control circuit 603 transmits data regarding the mold temperature controller 6 (hereinafter also referred to as temperature controller data) to the control device 700 via the communication I/F 601. A temperature set for the mold unit 800, actual data of the temperature of the mold unit 800, and flow rate data of a liquid that is used for temperature control are included in the data regarding the mold temperature controller 6.

### Injection Molding Machine

The injection molding machine 3 will be described. In the production system 1 according to the present embodiment, the number of injection molding machines 3 to be installed is not limited to one, and a plurality of injection molding machines 3 may be installed.

The injection molding machine 3 includes a mold clamping unit 100, an ejector unit 200, an injection unit 300, a moving unit 400, the control device 700, and a frame 900. The control device 700 is disposed in the internal space of the frame 900. Hereinafter, each component of the injection molding machine 3 will be described.

### Mold Clamping Unit

The mold clamping unit 100 performs mold closing, pressurization, mold clamping, depressurization, and mold opening of the mold unit 800. The mold unit 800 includes a stationary mold 810 and a movable mold 820. The mold clamping unit 100 is of, for example, a horizontal type, and mold opening and closing directions are a horizontal direction. The mold clamping unit 100 includes a stationary platen 110, a movable platen 120, a toggle support 130, a tie bar 140, a toggle mechanism 150, a mold clamping motor 160, a motion conversion mechanism 170, and a mold space adjustment mechanism 180.

The stationary platen 110 is fixed to the frame 900. The stationary mold 810 is mounted on a facing surface of the stationary platen 110 facing the movable platen 120. The movable platen 120 is disposed to be movable in the mold opening and closing directions with respect to the frame 900. The movable mold 820 is mounted on a facing surface of the movable platen 120 facing the stationary platen 110. The movable platen 120 advances and retreats with respect to the stationary platen 110, so that the mold closing, pressurization, mold clamping, depressurization, and mold opening of the mold unit 800 are performed. The toggle support 130 is disposed at a distance from the stationary platen 110 and placed on the frame 900 to be movable in the mold opening and closing directions. The tie bar 140 connects the stationary platen 110 and the toggle support 130 with a gap in the mold opening and closing directions.

The toggle mechanism 150 is disposed between the movable platen 120 and the toggle support 130 and moves the movable platen 120 with respect to the toggle support 130 in the mold opening and closing directions. The toggle mechanism 150 is composed of a crosshead 151, a pair of link groups, and the like. When the crosshead 151 advances and retreats with respect to the toggle support 130, the link group is bent and stretched, and the movable platen 120 advances and retreats with respect to the toggle support 130. The mold clamping motor 160 is mounted on the toggle support 130 and operates the toggle mechanism 150. The motion conversion mechanism 170 converts rotary motion of the mold clamping motor 160 into linear motion of the crosshead 151 to operate the toggle mechanism 150.

The mold clamping unit 100 performs a mold closing process, a pressurization process, a mold clamping process, a depressurization process, a mold opening process, and the like under the control of the control device 700.

In the mold closing process, the mold clamping motor 160 is driven to advance the crosshead 151 to a mold closing completion position at a set movement speed, thereby advancing the movable platen 120 and bringing the movable mold 820 into contact with the stationary mold 810.

In the pressurization process, the mold clamping motor 160 is further driven to further advance the crosshead 151 from the mold closing completion position to a mold clamping position, thereby generating a mold clamping force.

In the mold clamping process, the mold clamping motor 160 is driven to maintain the position of the crosshead 151 at the mold clamping position. In the mold clamping process, the mold clamping force generated in the pressurization process is maintained. In the mold clamping process, a cavity space 801 is formed between the movable mold 820 and the stationary mold 810, and the injection unit 300 fills the cavity space 801 with a liquid molding material. The molded article 10 is obtained by solidifying the filled molding material.

In the depressurization process, the mold clamping motor 160 is driven to retreat the crosshead 151 from the mold clamping position to a mold opening start position, thereby retreating the movable platen 120 and reducing the mold clamping force. The mold opening start position and the mold closing completion position may be the same position.

In the mold opening process, the mold clamping motor 160 is driven to retreat the crosshead 151 from the mold opening start position to a mold opening completion position at a set movement speed, thereby retreating the movable platen 120 and separating the movable mold 820 from the stationary mold 810. Thereafter, the ejector unit 200 ejects the molded article 10 from the movable mold 820.

In a case where the thickness of the mold unit 800 has changed due to replacement of the mold unit 800, a temperature change of the mold unit 800, or the like, mold space adjustment is performed such that a predetermined mold clamping force can be obtained during mold clamping. The mold space adjustment mechanism 180 performs the mold space adjustment by adjusting the distance between the stationary platen 110 and the toggle support 130. The timing of the mold space adjustment is, for example, between the end of a molding cycle and the start of the next molding cycle.

### Ejector Unit

The ejector unit 200 is mounted on the movable platen 120 and advances and retreats together with the movable platen 120. The ejector unit 200 performs an ejection process under the control of the control device 700. In the ejection process, a drive mechanism 220 advances an ejector rod 210 from a standby position to an ejection position at a set movement speed, thereby advancing a movable member 830 and ejecting the molded article 10. Thereafter, the drive mechanism 220 retreats the ejector rod 210 at the set movement speed and retreats the movable member 830 to the original standby position.

### Injection Unit

The injection unit 300 is disposed to be able to advance and retreat with respect to the mold unit 800. The injection unit 300 comes into contact with the mold unit 800 and fills the cavity space 801 in the mold unit 800 with the molding material. The injection unit 300 performs a plasticizing process, a filling process, a holding pressure process, and the like under the control of the control device 700. The filling process and the holding pressure process are collectively referred to as an injection process. In the plasticizing process, a predetermined amount of liquid molding material is accumulated. In the filling process, the cavity space 801 in the mold unit 800 is filled with the liquid molding material accumulated in the plasticizing process. In the holding pressure process, the holding pressure of the molding material is maintained at set pressure.

### Moving Unit

The moving unit 400 advances and retreats the injection unit 300 with respect to the mold unit 800.

### Control Device

The control device 700 is composed of, for example, a computer, and includes a CPU (central processing unit) 701, a storage medium 702 such as a memory, an input interface 703, an output interface 704, a first communication interface 705, a second communication interface 706, and a third communication interface 707, as shown in FIG. 3. The control device 700 performs various controls by causing the CPU 701 to execute a program stored in the storage medium 702. Further, the control device 700 receives a signal from the outside through the input interface 703 and transmits a signal to the outside through the output interface 704.

The control device 700 repeatedly performs the plasticizing process, the mold closing process, the pressurization process, the mold clamping process, the filling process, the holding pressure process, a cooling process, the depressurization process, the mold opening process, the ejection process, and the like, thereby repeatedly producing the molded articles 10. A series of operations for obtaining the molded article 10, for example, an operation from the start of the plasticizing process to the start of the next plasticizing process, is also referred to as a “shot” or a “molding cycle”. Further, a time required for one shot is also referred to as a “molding cycle time” or a “cycle time”.

One molding cycle includes, for example, a plasticizing process, a mold closing process, a pressurization process, a mold clamping process, a filling process, a holding pressure process, a cooling process, a depressurization process, a mold opening process, and an ejection process in this order. The order here is an order of the start of each process. The filling process, the holding pressure process, and the cooling process are performed during the mold clamping process. The start of the mold clamping process may coincide with the start of the filling process. The end of the depressurization process coincides with the start of the mold opening process.

A plurality of processes may be performed simultaneously for the purpose of shortening the molding cycle time.

One molding cycle may include processes other than the plasticizing process, the mold closing process, the pressurization process, the mold clamping process, the filling process, the holding pressure process, the cooling process, the depressurization process, the mold opening process, and the ejection process.

The control device 700 is connected to an operation unit 750 or a display unit 760. The operation unit 750 receives an input operation from the user and outputs a signal corresponding to the input operation to the control device 700. The display unit 760 displays a display screen corresponding to the input operation in the operation unit 750 under the control of the control device 700.

The display screen is used for setting or the like of the injection molding machine 3. A plurality of display screens are prepared and displayed in a switched manner or displayed in an overlapping manner. The user performs the setting (including input of setting values) or the like of the injection molding machine 3 by operating the operation unit 750 while viewing the display screen displayed on the display unit 760.

The operation unit 750 and the display unit 760 may be configured with, for example, a touch panel 770 to be integrated with each other. Although the operation unit 750 and the display unit 760 of the present embodiment are integrated with each other, they may be provided independently. Further, a plurality of operation units 750 may be provided.

The third communication interface 707 is an interface for performing communication with the management system server 2 connected via the public network 8.

The first communication interface 705 is an interface for performing communication between the material dryer 5 and the mold temperature controller 6 via a communication line.

In a case where the first communication interface 705 receives the dryer data, the CPU 701 of the control device 700 stores the received dryer data in the storage medium 702. The dryer data is used at the time of writing to the RFID tags 55A to 55D.

In a case where the first communication interface 705 receives the temperature controller data, the CPU 701 of the control device 700 stores the received temperature controller data in the storage medium 702. The temperature controller data is used at the time of writing to the RFID tags 55A to 55D.

The second communication interface 706 is an interface for performing communication with the RFID reader/writer 31 via a communication line.

In a case where the molded article 10 has been molded, the CPU 701 reads the information stored in the storage medium 702 and issues a writing instruction to the RFID reader/writer 31 (an example of a first writing unit) via the second communication interface 706. Next, writing that is performed in the molding process will be described.

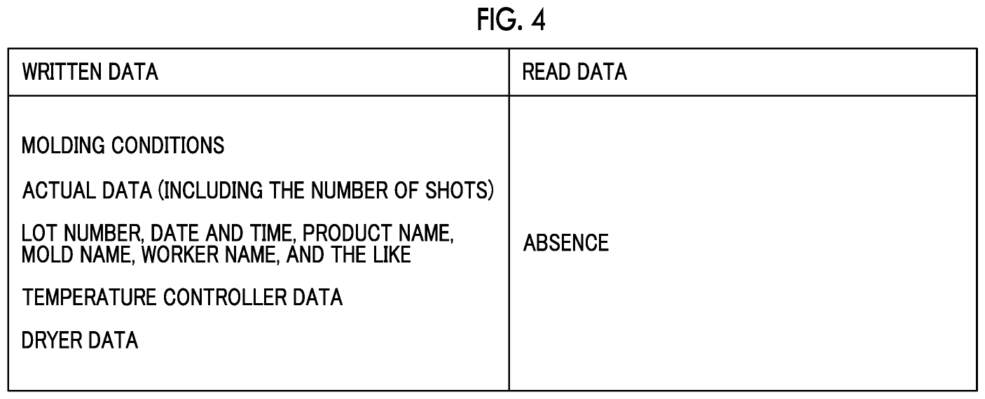

FIG. 4 is a diagram illustrating information read and written with respect to the RFID tags 55A to 55D by the RFID reader/writer 31 in the molding process according to the present embodiment. As shown in FIG. 4, in the molding process, the data that is written in the RFID tags 55A to 55D includes information for specifying the molded article 10 of the current process, information indicating a situation of the molding of the current process, and the like. Specifically, the data includes “molding conditions”, “actual data”, “lot number, date and time, product name, mold name, worker name, and the like”, “temperature controller data”, and “dryer data”. As shown in FIG. 4, in the molding process, there is no data that is read by the RFID reader/writer 31.

The “molding conditions” indicate conditions set by a worker for molding of the current process. For example, a setting temperature, a cooling time, and the like set in the mold unit 800 are included.

The “actual data” is information acquired by a sensor (not shown) or the like in the molding of the current process and includes, for example, peak filling pressure of a cylinder of the injection molding machine 3, mold internal pressure of the mold unit 800, a cylinder temperature of the injection molding machine 3, and the number of shots indicating the number of times of injection of the cylinder of the injection molding machine 3.

The “lot number, date and time, product name, mold name, worker name, and the like” are information for specifying the molding of the current process and are information input to the injection molding machine 3.

The “temperature controller data” is information transmitted from the mold temperature controller 6, and includes, for example, the temperature set for the mold unit 800, the actual data of the temperature of the mold unit 800, and the flow rate data of water that is used for temperature control.

The “dryer data” is information transmitted from the material dryer 5, and includes the temperature set for drying, and the actual data of a drying temperature of the molding material.

In the molding process, as described above, in a case where the molded article 10 has been molded, the CPU 701 of the control device 700 writes the above-described information in each of the RFID tags 55A to 55D via the RFID reader/writer 31.

In the present embodiment, an example in which all the information generated in the molding process is managed with the RFID tags 55A to 55D is described. However, the present embodiment is not limited to the method in which all the information generated in the molding process is managed with the RFID tags 55A to 55D. For example, only the information necessary for identifying the molded article 10, such as the number of shots or the molding date and time, may be written in the RFID tags 55A to 55D, and the RFID reader/writer 31 may transmit, together with the information necessary for identifying the molded article 10, a large amount of other information (for example, information of molding conditions, various actual values, and the like) to the management system server 2. In this way, the management system server 2 can manage the information necessary for the identification and other information (information of molding conditions, various actual values, and the like) of the injection molding machine 3 in association with each other in the storage device 15.

Returning to FIG. 1, the take-out/carry-out process is a process subsequent to the molding process, and is a process in which the molded article 10 molded in the injection molding machine 3 is taken out and in which the molded article 10 is carried out. The process is performed by the take-out robot 4.

The take-out robot 4 (an example of a disposition unit) is a device for taking out the molded article 10 molded in the injection molding machine 3 and storing the taken-out molded article 10 in the storage container 50. The take-out robot 4 has the RFID reader/writer 32 on an arm for performing the take-out and storing of the molded article 10.

The take-out robot 4 according to the present embodiment stores each molded article 10 taken out from each cavity of the mold unit 800 of the injection molding machine 3 in each of the storage areas 51A to 51D of the storage container 50.

The RFID reader/writer 32 (an example of a second writing unit) performs the reading and writing of data on each of the RFID tags 55A to 55D. The arm of the take-out robot 4 of the present embodiment stores the molded article 10 in each of the storage areas 51A to 51D of the storage container 50. When the arm stores the molded article 10, the RFID reader/writer 32 provided on the arm performs the reading and writing of information about the molded article 10 to be stored with respect to the RFID tags 55A to 55D corresponding to the storage areas 51A to 51D of the storage destination.

When the take-out robot 4 of the present embodiment stores the molded article 10 in the storage container 50, the reading and writing of information about the molded article 10 is performed on each of the RFID tags 55A to 55D from the RFID reader/writer 32.

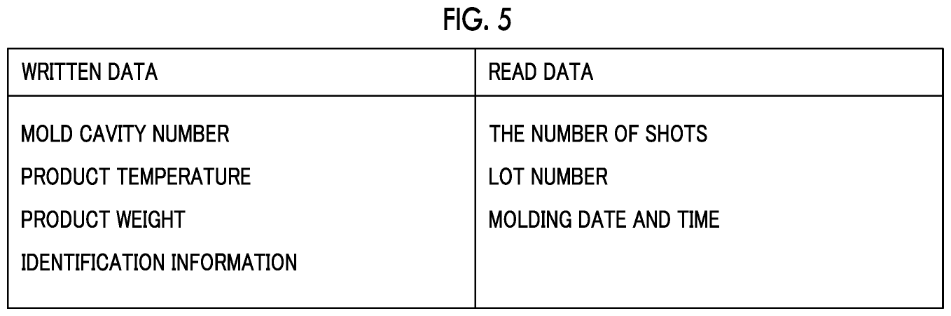

FIG. 5 is a diagram illustrating information read and written with respect to the RFID tags 55A to 55D by the RFID reader/writer 32 in the take-out/carry-out process according to the present embodiment. As shown in FIG. 5, in the take-out/carry-out process, the RFID reader/writer 33 reads, for example, “the number of shots”, “lot number”, and “molding date and time” from the RFID tags 55A to 55D.

The take-out robot 4 according to the present embodiment generates “identification information” for identifying the molded article 10, based on the read information “the number of shots”, “lot number”, and “molding date and time”, and the number indicating the cavity of the mold unit 800. The “identification information” is information that can uniquely specify one molded article 10 by combining information about the molding of the current process and information indicating the cavity.

In the take-out/carry-out process, the data that is written to the RFID tags 55A to 55D includes information indicating the molded article 10 to be stored. Specifically, the information indicating the molded article 10 includes “mold cavity number”, “product temperature”, “product weight”, and “identification information”.

The “mold cavity number” is the number indicating the cavity of the mold unit 800 from which the molded article 10 is taken out.

The “product temperature” indicates the temperature of the taken-out molded article 10. The “product weight” indicates the load of the taken-out molded article. The “product temperature” and the “product weight” are numerical values detected by sensors (not shown) provided on the take-out robot 4 when the take-out robot 4 takes out the molded article.

The “identification information” is the unique number for each molded article 10 generated according to “the number of shots”, “lot number”, “molding date and time”, and “mold cavity number”.

In the take-out/carry-out process, as described above, when the take-out robot 4 stores the molded article 10 in the storage container 50, the RFID reader/writer 32 reads “the number of shots”, “lot number”, and “molding date and time” from the RFID tags 55A to 55D, and writes “mold cavity number”, “product temperature”, “product weight”, and “identification information” in the RFID tags 55A to 55D.

Returning to FIG. 1, the inspection process is a process subsequent to the take-out/carry-out process, and is a process of performing the inspection of the molded article 10. The process is performed by the image inspection device 9. The image inspection device 9 according to the present embodiment is not connected to the public network 8. Therefore, in the present embodiment, the inspection result is written in the RFID tags 55A to 55D in order to transfer the inspection result to a post-process.

That is, in the post-process of molding of the molded article 10, depending on a situation or the like in a factory, there is a case where all the devices in the factory are not connected to the public network 8. In this manner, in the present embodiment, it is possible to transfer information by using the RFID tags 55A to 55D without connection to the public network 8.

The image inspection device 9 performs the inspection of the molded article 10, based on image data obtained by an imaging unit (not shown) of the molded article 10 stored in each of the storage areas 51A to 51D of the storage container 50. The inspection is, for example, appearance inspection of the molded article 10, and it is determined whether or not there is a defect in the appearance.

The image inspection device 9 is connected to the RFID reader/writer 33. The RFID reader/writer 33 reads information from the RFID tags 55A to 55D when the image inspection device 9 performs appearance inspection.

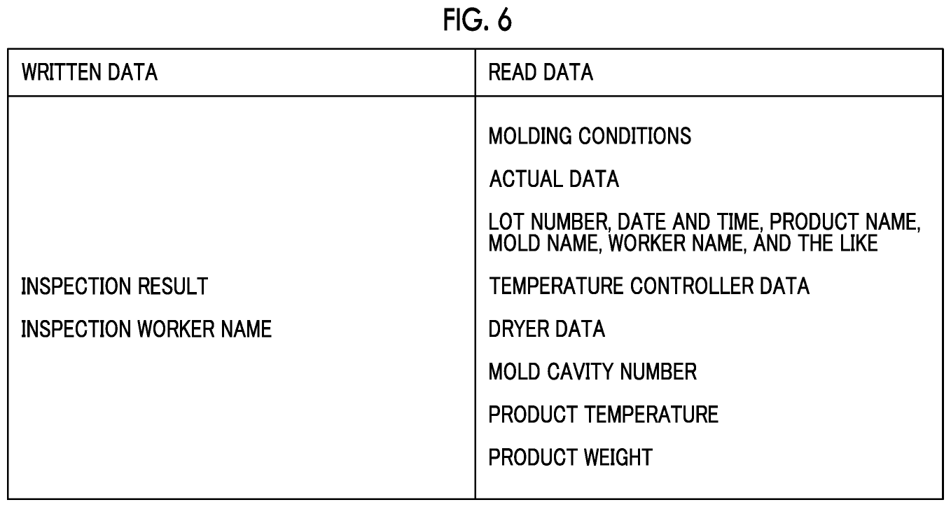

FIG. 6 is a diagram illustrating information read and written with respect to the RFID tags 55A to 55D by the RFID reader/writer 33 in the inspection process according to the present embodiment. As shown in FIG. 6, in the inspection process, the RFID reader/writer 33 (an example of a first reading unit) reads, for example, “molding conditions”, “actual data”, “lot number, date and time, product name, mold name, worker name, and the like”, “temperature controller data”, “dryer data”, “product temperature”, and “product weight” from the RFID tags 55A to 55D.

The image inspection device 9 (an example of a processing unit) according to the present embodiment generates a determination criterion indicating a reference of whether or not a product is defective, based on the read information. Then, the image inspection device 9 determines whether or not the molded article 10 is defective, based on the generated determination criterion. In the present embodiment, in this manner, the appearance inspection of the molded article 10 is performed in consideration of an environment when the molded article 10 is molded. In this way, highly accurate appearance inspection can be realized. The present embodiment is an example of generating a determination criterion based on read information. However, the present embodiment is not limited to the method in which data is read from the RFID tags 55A to 55D in order to generate a determination criterion, and, for example, the determination criterion may be fixed.

After the inspection is ended, the image inspection device 9 writes the inspection result in each of the RFID tags 55A to 55D by using the RFID reader/writer 33 (an example of a second writing unit). In the present embodiment, the result of the inspection performed for each molded article 10 is written in the RFID tags 55A to 55D corresponding to the molded articles 10.

In the inspection process, the RFID reader/writer 33 writes “inspection result” and “inspection worker name” in the RFID tags 55A to 55D.

The “inspection result” is information indicating the inspection result by the image inspection device 9. In a case where the image inspection device 9 determines that inspection is necessary, the determination result is also included. The “inspection worker name” indicates the name of a worker who performed the work by using the image inspection device 9.

In this way, the inspection result in the inspection process is written in the RFID tags 55A to 55D. In this way, in the present embodiment, even if the image inspection device 9 is not connected to a network, the inspection result can be transferred to a post-process.

Returning to FIG. 1, the packaging process is a process subsequent to the inspection process, and is a process of performing packaging for shipment of the molded article 10. The process may be performed by a packaging device or may be performed by a worker. In a case where the process is performed by a worker, when the worker packs the molded article 10, the worker reads the information written in the processes up to this point from the RFID tags 55A to 55D indicating the molded articles 10 to be packed by using the RFID reader/writer 34.

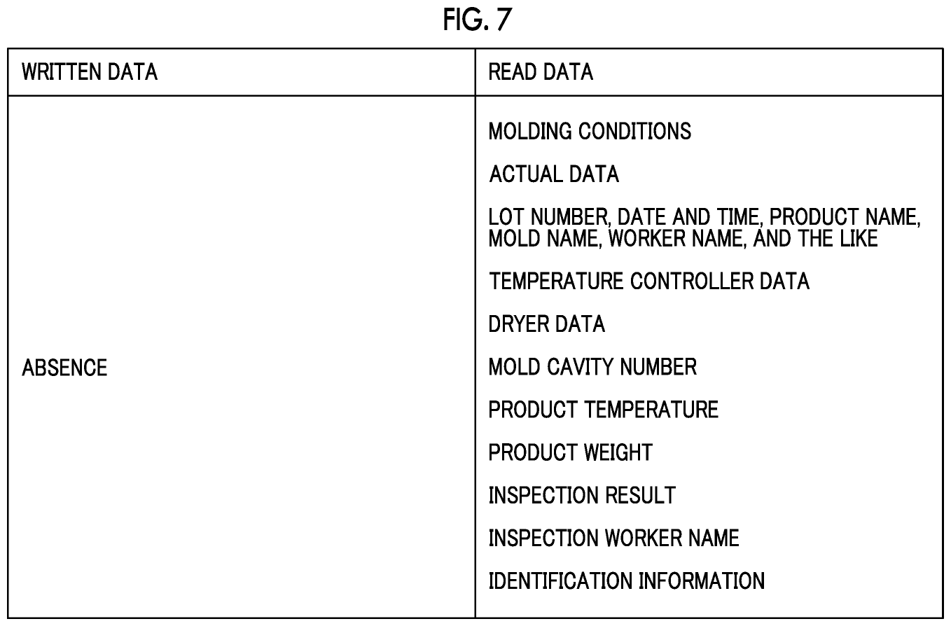

FIG. 7 is a diagram illustrating information read and written with respect to the RFID tags 55A to 55D by the RFID reader/writer 34 in the packaging process according to the present embodiment. As shown in FIG. 7, in the packaging process, the RFID reader/writer 34 (an example of a second reading unit) reads, for example, “molding conditions”, “actual data”, “lot number, date and time, product name, mold name, worker name, and the like”, “temperature controller data”, “dryer data”, “product temperature”, “product weight”, “inspection result”, “inspection worker name”, and “identification information” from the RFID tags 55A to 55D. In the example shown in FIG. 7, in the packaging process, there is no data that is written by the RFID reader/writer 34. However, data may be written as necessary. As data to be written, for example, a secondary inspection result or the like can be considered. In such a case, after data is written in the packaging process, the processing may proceed by reading all the data.

The worker checks the information written in the “inspection result”, and in a case where it is determined that a secondary inspection is necessary for a molded article 10, the necessary secondary inspection is performed on the molded article 10.

The RFID reader/writer 34 (an example of a transmitting unit) has a communication I/F (not shown). The RFID reader/writer 34 transmits all the read information to the management system server 2 via the public network 8. The management system server 2 writes the received information in the storage device 15.

In the present embodiment, the worker packs each molded article 10 into a packing bag. Further, in order to associate the packed molded article 10 with the information that is managed by the management system server 2, the RFID reader/writer 34 may attach a two-dimensional code indicating the identification information read by the RFID reader/writer 34 (uniquely indicating the molded article 10) to a packing bag 70 in which the molded article 10 is packed. In this way, even after shipment, the entire situation can be traced from the molding of the molded article 10 until after shipment.

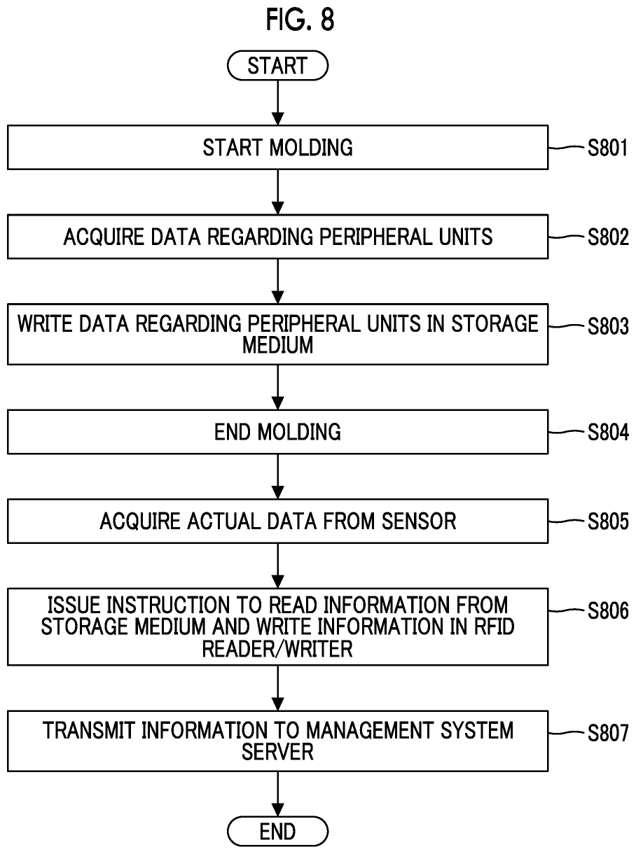

Next, a processing procedure that is performed in the molding process according to the production system 1 according to the present embodiment will be described. FIG. 8 is a flowchart showing the processing procedure that is performed in the molding process according to the production system 1 according to the present embodiment. In the storage medium 702, information of molding conditions, a lot number, a date and time, a product name, a mold name, a worker name, and the like is stored in advance.

First, the injection molding machine 3 starts molding (S801). Next, the CPU 701 of the control device 700 of the injection molding machine 3 acquires data regarding peripheral units (the dryer data and the temperature controller data) from the peripheral units (for example, the material dryer 5 and the mold temperature controller 6) via the first communication interface 705 (S802).

Further, the CPU 701 writes the acquired information in the storage medium 702 (S803).

Then, the molding of the injection molding machine 3 is ended (S804). The CPU 701 acquires actual data from a sensor (not shown) or the like (S805). The acquisition of the actual data from a sensor or the like shown in S805 may be performed before the molding of the injection molding machine 3 is completed, and the data may be written in the storage medium 702 according to the procedure of S806 shown below.

The CPU 701 instructs the RFID reader/writer 31 to read information from the storage medium and write the information read from the storage medium 702 and the actual data in all of the RFID tags 55A to 55D (S806). The RFID reader/writer 31 writes the information read from the storage medium 702 and the actual data in the RFID tags 55A to 55D in response to the instruction.

Further, the CPU 701 transmits the information read from the storage medium 702 and the actual data to the management system server 2 (S807). In this way, the molding process is ended.

In the molding process of the present embodiment, information about the molding process is written in the RFID tags 55A to 55D by performing the processing procedure described above. Further, since the information is also transmitted to the management system server 2, it becomes possible to manage the situation regarding the molding process.

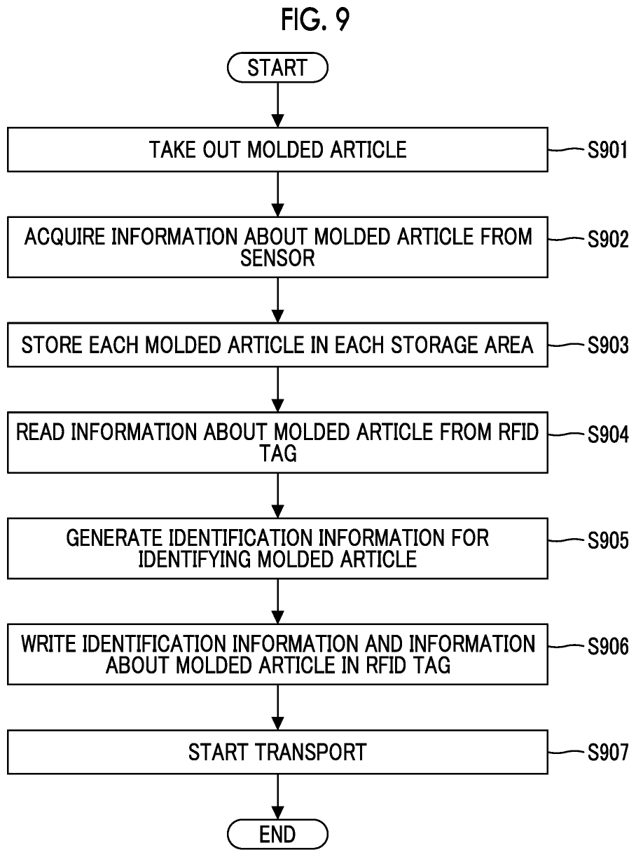

Next, a processing procedure that is performed in the take-out/carry-out process according to the production system 1 according to the present embodiment will be described. FIG. 9 is a flowchart showing the processing procedure that is performed in the take-out/carry-out process according to the production system 1 according to the present embodiment.

First, the take-out robot 4 takes out the molded article 10 from the mold unit 800 of the injection molding machine 3 (S901). In the present embodiment, the arm of the take-out robot 4 may simultaneously take out a plurality of molded articles 10 molded for each cavity, or the arm may take out the molded articles 10 molded for each cavity one by one.

The take-out robot 4 acquires information (product temperature and product weight) about the taken-out molded article 10 from sensors (not shown) (S902).

The take-out robot 4 stores each of the taken-out molded articles 10 in each of the storage areas partitioned so as to match the number of cavities (S903).

When the take-out robot 4 stores the molded article 10, the RFID reader/writer 32 reads information about the molded article 10 from the RFID tags 55A to 55D associated with the storage areas (S904).

The take-out robot 4 generates identification information, based on the read information (S905).

The take-out robot 4 writes a mold cavity number from which the molded article 10 has been taken out, and information about the molded article 10 (product temperature and product weight), together with the generated identification information, from the RFID reader/writer 32 in the RFID tags 55A to 55D (S906).

When storage of the molded article 10 in the storage container 50 is completed, the belt conveyor 7 starts transport of the storage container 50 according to an instruction from the take-out robot 4 (S907). In this way, the take-out/carry-out process is ended.

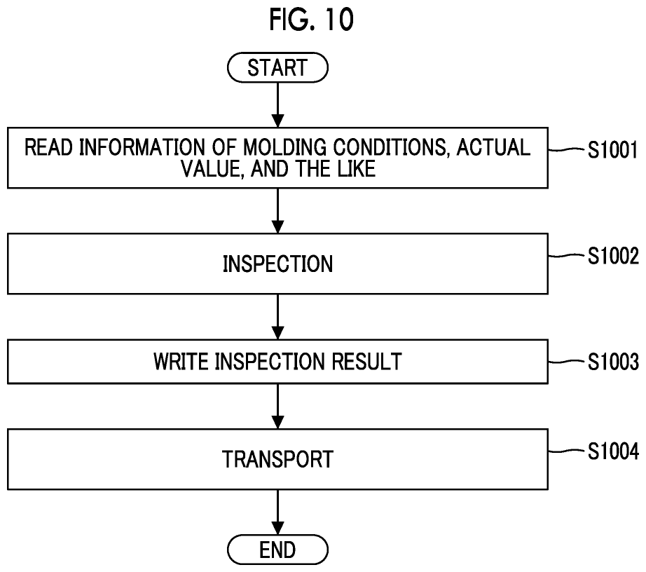

Next, a processing procedure that is performed in the inspection process according to the production system 1 according to the present embodiment will be described. FIG. 10 is a flowchart showing the processing procedure that is performed in the inspection process according to the production system 1 according to the present embodiment. In the present embodiment, transport is performed in the storage container 50 unit by the belt conveyor 7 from the take-out/transport process to the inspection process.

First, the image inspection device 9 reads information that is used for a determination criterion for inspection, such as molding conditions and an actual value, from the RFID tags 55A to 55D by using the RFID reader/writer 33 (S1001).

The image inspection device 9 performs inspection for each molded article 10 according to the determination criterion corresponding to each molded article 10, based on the read information (S1002).

The image inspection device 9 writes the inspection result and the like for each molded article 10 in the RFID tags 55A to 55D corresponding to the molded article 10 by using the RFID reader/writer 33 (S1003).

When the inspection of each molded article 10 stored in the storage container 50 is completed, the belt conveyor 7 transports the storage container 50 according to an instruction from the image inspection device 9 or an operation from an inspection worker (S1004). In this way, the inspection process is ended.

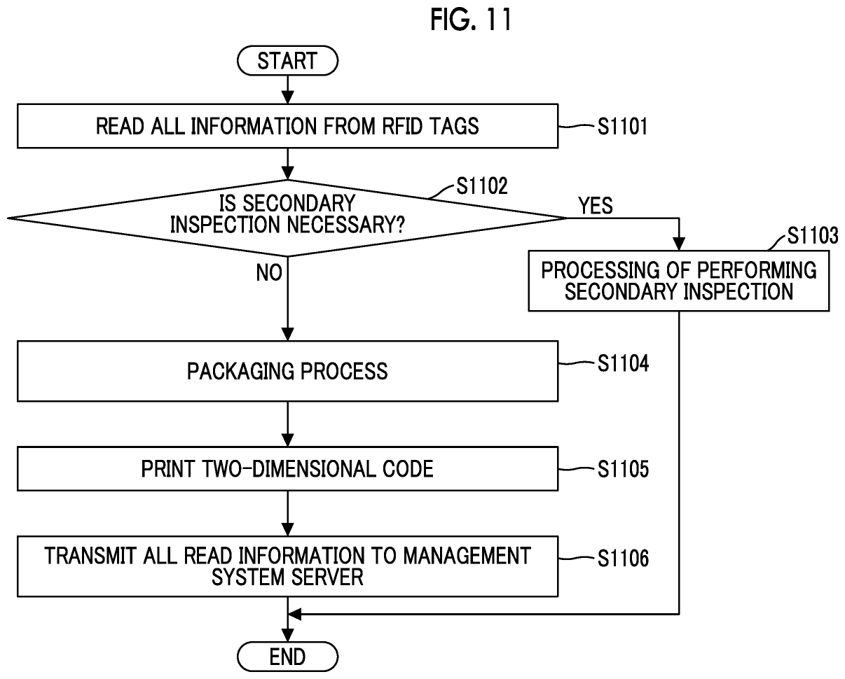

Next, a processing procedure that is performed in the transport process according to the production system 1 according to the present embodiment will be described. FIG. 11 is a flowchart showing the processing procedure that is performed in the transport process according to the production system 1 according to the present embodiment. In the present embodiment, transport is performed in the storage container 50 unit by the belt conveyor 7 from the inspection process to the transport process.

First, the RFID reader/writer 34 reads all information from the RFID tags 55A to 55D corresponding to the molded article 10, based on an operation from a worker (S1101).

The worker determines whether or not secondary inspection is necessary, based on the “inspection result” displayed as the information read by the RFID reader/writer 34 (S1102).

In a case where it is determined that the secondary inspection is necessary (S1102: Yes), processing is performed to perform the secondary inspection (S1103), and the processing is ended. In a case where, as a result of the secondary inspection, the molded article is determined to be non-defective, the routine may proceed to the packaging process of S1104. Further, the result of the secondary inspection may be written in the RFID tags 55A to 55D. In a case where the result or the like of the secondary inspection is written in the RFID tags 55A to 55D, the RFID reader/writer 34 may read all the information again.

On the other hand, in a case where it is determined that the secondary inspection is not necessary (S1102: No), the packaging process is performed (S1104). Thereafter, a printing device connected to the RFID reader/writer 34 prints a two-dimensional code indicating the identification information (S1105). The worker attaches the printed two-dimensional code to the packing bag 70.

Then, the RFID reader/writer 34 transmits all the information read from the RFID tags 55A to 55D to the management system server 2 (S1106).

All information after molding can be managed by the management system server 2 according to the processing procedure described above, and the two-dimensional code is attached to the packing bag 70. Therefore, even after the shipment, with respect to the molded article 10, all the situations from the molding to the shipment can be identified.

Further, after the transport process is completed, the storage container 50 is used again from the molding process. As in the present embodiment, the storage container 50 and the RFID tags 55A to 55D attached to the storage container 50 are used in association with another molded article 10 after shipment of the associated molded article 10. In this manner, in the present embodiment, since the storage container 50 and the RFID tags 55A to 55D attached to the storage container 50 are reusable, costs can be reduced.

In the present embodiment, an example in which identification information is generated in the take-out/carry-out process has been described. However, the generation of identification information for identifying the molded article 10 is not limited to the take-out/carry-out process, and it is favorable if the identification information is generated before all the information is transmitted to the management system server 2. For example, in the packaging process, the identification information may be generated at a stage when all information is read from the RFID tags 55A to 55D.

In the present embodiment described above, as an example of the processing unit, the image inspection device 9 that performs appearance inspection has been described. However, in the present embodiment, the processing unit is not limited to the image inspection device 9, and any means that performs processing based on the read information indicating the molded article 10 may be used.

In the present embodiment described above, an example in which an RFID tag is associated with each molded article 10 has been described. However, the present embodiment described above is not limited to the example in which each molded article 10 is associated with an RFID tag. For example, in a case where the injection molding machine 3 molds a plurality of molded articles 10 at one time, the plurality of molded articles 10 may be managed in association with one RFID tag.

In the present embodiment described above, an example in which the storage container 50 is used to associate each of the RFID tags 55A to 55D with the molded article 10 has been described. In the present embodiment, the shape of the storage container that stores the molded article 10 is not limited, and, for example, it is favorable if the storage container has a bag shape or the like. In this case, the molded article 10 may be stored in a bag or the like to which an RFID tag is attached, and the RFID tag and the molded article 10 may be managed in association with each other. Furthermore, the RFID tag may be directly attached to the molded article 10 without being limited to the method using the storage container.

In the present embodiment described above, an example in which an RFID tag is used as a storage medium that is associated with the molded article 10 has been described. By using the RFID tag, information can be read and written by proximity wireless communication. Therefore, even in a case where there are a plurality of processing processes as described above, each processing process has a different environment, and reading and writing is necessary for each processing process, it is easy to read and write information, so that the burden of each processing process can be reduced.

Further, in the present embodiment described above, each molded article 10 is managed in association with an RFID tag in a post-process after molding. Appropriate management of each molded article 10 can be realized by reading and writing information about the molded article 10 for each processing process. Furthermore, the accuracy of quality control of the molded article 10 can be improved.

Further, in the present embodiment described above, each molded article 10 is managed in association with the mold cavity number (information that identifies the cavity). In this way, in a case where a defective molded article 10 is found in the inspection, the cavity in which the defect has occurred can be identified. In this way, it becomes possible to analyze whether a defect is likely to occur in a specific cavity at an analysis stage. Accordingly, it is possible to specify the molded article 10 in which a defect is likely to occur, so that quality control can be improved.

Although the embodiment of the molded article production system according to the present invention has been described above, the present invention is not limited to the above embodiment and the like. Various changes, modifications, substitutions, additions, deletions, and combinations can be made within the scope stated in the claims. These also naturally belong to the technical scope of the present invention.

It should be understood that the invention is not limited to the above-described embodiment, but may be modified into various forms on the basis of the spirit of the invention. Additionally, the modifications are included in the scope of the invention.

What is claimed is:

1. A molded article production system comprising:
a first writing unit that writes first information about a molded article molded by an injection molding machine in a readable/writable storage medium; and
a transport unit that transports the molded article and the storage medium in which the first information of the molded article is written in association with each other.

2. The molded article production system according to claim 1, further comprising:
a second writing unit that writes, in a case where processing is performed on the molded article after the molded article is transported by the transport unit, second information about the processing in the storage medium transported in association with the molded article by the transport unit.

3. The molded article production system according to claim 1, further comprising:
a disposition unit that disposes each molded article molded for each of cavities of the injection molding machine in each partitioned area with respect to a storage container including partitions corresponding to the number of the cavities of the injection molding machine,
wherein the first writing unit writes the first information in each storage medium provided for each partitioned area of the storage container, and
the transport unit transports the storage container.

4. The molded article production system according to claim 1, further comprising:
a first reading unit that reads the first information from the storage medium transported together with the molded article by the transport unit; and
a processing unit that performs predetermined processing on the molded article by using the first information read by the first reading unit.

5. The molded article production system according to claim 1, further comprising:
a second reading unit that reads the first information from the storage medium transported together with the molded article by the transport unit; and
a transmitting unit that transmits the first information read by the second reading unit to a server that manages information on the molded article via a network.
